(19) United States
(12) Patent Application Publication
(10) Pub. No.: US 2018/0269545 A1
(43) Pub. Date: Sep. 20, 2018

(54) POWER BATTERY PACK AND ELECTRICAL VEHICLE HAVING THE SAME

(71) Applicant: BYD COMPANY LIMITED, SHENZHEN (CN)

(72) Inventors: DESHENG LIU, SHENZHEN (CN); QINGBO PENG, SHENZHEN (CN); WEIXIN ZHENG, SHENZHEN (CN); JIANHUA ZHU, SHENZHEN (CN); YAN ZHU, SHENZHEN (CN)

(21) Appl. No.: 15/982,325

(22) Filed: May 17, 2018

Related U.S. Application Data
(63) Continuation of application No. PCT/CN2016/106662, filed on Nov. 21, 2016.

(30) Foreign Application Priority Data
Nov. 24, 2015 (CN) 201510824394.7

(51) Int. Cl. H01M 10/613; B60L 11/18; H01M 10/625; H01M 10/6552; H01M 10/6554; H01M 2/10

(52) U.S. Cl. CPC H01M 10/613; B60L 11/1874; B60L 11/1879; H01M 2220/20; H01M 10/6552; H01M 10/6554; H01M 2/1077; H01M 10/625

(57) ABSTRACT

A power battery pack and an electrical vehicle including the same are provided. The power battery pack includes: a tray; a plurality of battery modules disposed in the tray, and including a first battery module disposed on the tray and a second battery module stacked on the first battery module; a second module cooling plate disposed outside of the second battery module, and including a first bottom plate and a first side plate; and a first side heat-conducting plate disposed at an outer side of the first side plate and heat-conductively connected therewith, wherein both the first bottom plate and the first side plate have a heat pipe disposed therein respectively, the heat pipes of the first bottom plate and the first side plate are in communication with each other; and the first side heat-conducting plate has a heat pipe disposed therein and heat-conductively connected to the tray.

### CROSS-REFERENCE TO RELATED APPLICATION

This application is a continuation application of International Patent Application No. PCT/CN2016/106662, filed on Nov. 21, 2016, which claims priority to and benefits of Chinese Patent Application No. 201510824394.7, filed with the State Intellectual Property Office of P. R. China on Nov. 24, 2015. The entire content of the above-referenced applications is incorporated herein by reference.

### FIELD

The present disclosure generally relates to a field of battery, especially relates to a field of power battery used in electrical vehicles.

### BACKGROUND

In current electrical vehicles, space reserved for installing a power battery pack becomes less and less. In order to reasonably arrange the power battery pack within a limited space, a conventional way of arranging battery modules in the power battery hack along a horizontal direction cannot meet the actual need any longer. In most cases, the battery modules are arranged in two or more stacked layers.

When the battery modules are arranged in two or more stacked layers, the battery modules, especially the upper layer of battery modules, would have a poor heat dissipating performance, and a problem of uneven temperature may arise.

### SUMMARY

The present disclosure seeks to solve at least one of the technical problems in the related art to some extent. Therefore, embodiments of the present disclosure provide a power battery pack and an electrical vehicle having the same.

According a first aspect of embodiments of the present disclosure, a power battery pack is provided, and the power battery pack includes: a tray; a plurality of battery modules disposed in the tray, the plurality of battery modules including a first battery module disposed on the tray and a second battery module stacked on the first battery module; a second module cooling plate disposed outside of the second battery module, the second module cooling plate including a first bottom plate disposed to a bottom of the second battery module and a first side plate connected to a side surface of the second battery module; and a first side heat-conducting plate disposed at an outer side of the first side plate of the second module cooling plate and heat-conductively connected with the first side plate, in which both the first bottom plate and the first side plate have a heat pipe disposed therein respectively, the heat pipe of the first bottom plate and the heat pipe of the first side plate are in communication with each other to transfer heat of the first bottom plate to the first side plate, and the first side heat-conducting plate has a heat pipe disposed therein and heat-conductively connected to the tray.

With the power battery pack according to embodiments of the present disclosure, the battery module can be arranged along a horizontal direction and in multiple stacked layers within a limited space depending on a reserved space of the electrical vehicle, in which the module cooling plate and the side heat-conducting plate occupy only a small space, and the heat pipes disposed in the module cooling plate and the side heat-conducting plate transfer heat fast, so heat generated from the battery module can be transferred to the tray evenly, quickly and efficiently, so as to dissipate heat. Moreover, the power battery pack has a simple structure and a relative low cost.

According to a second aspect of embodiments of the present disclosure, an electrical vehicle is provided, and the electrical vehicle includes a power battery pack mentioned above.

With the electrical vehicle according to embodiments of the present disclosure, which includes the power battery pack mentioned above, the battery module can be arranged along a horizontal direction and in multiple stacked layers within a limited space depending on a reserved space of the electrical vehicle, in which the module cooling plate and the side heat-conducting plate occupy only a small space, and the pipes disposed in the module cooling plate and the side heat-conducting plate transfer heat fast, so heat generated from the battery module can be transferred to the tray evenly, quickly and efficiently, so as to dissipate heat.

### BRIEF DESCRIPTION OF THE DRAWINGS

FIG. 1 is a schematic view of a power battery pack according to an embodiment of the present disclosure;

FIG. 2 is a schematic view of stacked battery modules according to an embodiment of the present disclosure;

FIG. 3 is a section view of a power battery pack according to an embodiment of the present disclosure;

FIG. 4 is a schematic view of a battery module according to an embodiment of the present disclosure;

FIG. 5 is a schematic view of a second module heat-conducting pad of a second battery module according to an embodiment of the present disclosure;

FIG. 6 is a schematic view of a first module cooling plate according to an embodiment of the present disclosure;

FIG. 7 is a schematic view of a second module cooling plate according to an embodiment of the present disclosure;

FIG. 8 is a schematic view of a side heat-conducting plate according to an embodiment of the present disclosure;

FIG. 9 is an enlarged view of part A in FIG. 3,

FIG. 10 is an enlarged view of part B in FIG. 3;

FIG. 11 is a schematic view of a second battery module in a fastened state according to an embodiment of the present disclosure;

FIG. 12 is a schematic view of a first battery module in a fastened state according to an embodiment of the present disclosure; and

FIG. 13 is a schematic view of a first battery module and a second battery module stacked and installed together according to an embodiment of the present disclosure.

### DETAILED DESCRIPTION

Embodiments of the present disclosure are described in detail below, and examples of the embodiments are shown in accompanying drawings. The following embodiments described by referring to the accompanying drawings are illustrative, aim at explaining the present disclosure, and should not be interpreted as limitations to the present disclosure.

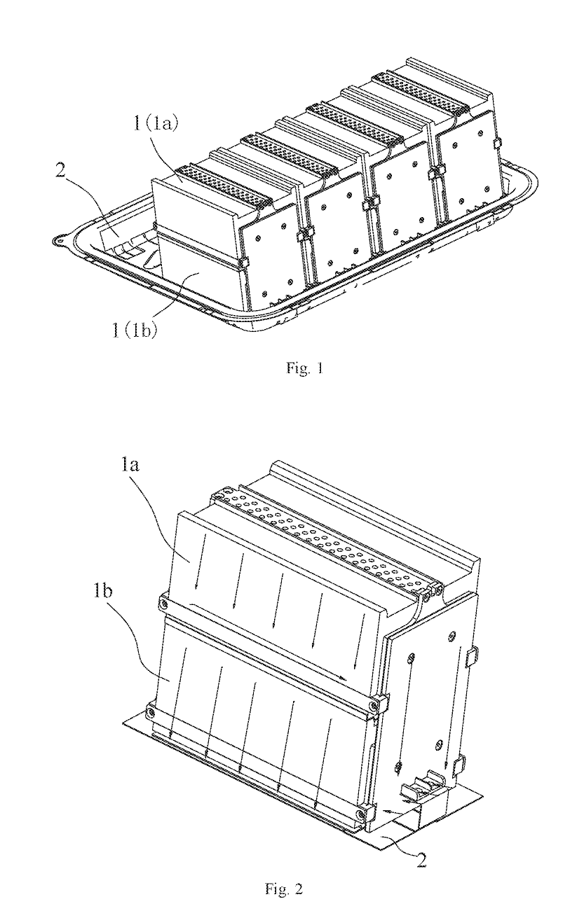

Embodiments of the present disclosure provide a power battery pack, and the power battery pack will be described and explained in detail below by referring to the drawings. As shown in FIG. 1 and FIG. 2, the power battery pack includes a tray 2 and a plurality of battery modules 1 disposed in the tray 2, and at least part of the battery modules 1 are stacked in layers.

The battery module 1 includes a plurality of single batteries, and some positioning and fixing structures combined with the single batteries.

The tray 2 is configured for receiving the above battery modules 1 and installing the power battery pack according to embodiments of the present disclosure in an electrical vehicle via fasteners, such as bolts. In some embodiments, the tray 2 is made of metal materials having good heat conductivity and mechanical strength, such as stainless steel, aluminum, aluminum alloy, copper, copper alloy and magnalium.

In some embodiments, part of the battery modules 1 is horizontally laid on the tray 2 to form a first layer of battery modules 1, a second layer of battery modules 1 may be laid on an upper surface of the first layer of battery modules 1, and a third layer of battery modules 1 may be also laid on an upper surface of the second layer of battery modules 1, and so on. The number of layers in which the battery modules 1 are stacked can be determined according to an installation space of the power battery pack, which is not limited in embodiments of the present disclosure. For the purpose of describing and explaining, only two layers of stacked battery modules 1 are shown in the figures. As shown in FIGS. 1-3, in order to facilitate subsequent descriptions, in the two layers of stacked battery modules 1, a lower layer of battery modules 1 is called a first battery modules 1b, and an upper layer of battery modules 1 is called a second battery modules 1a. That is, the battery modules 1 include the first battery modules 1b disposed on the tray 2 and the second battery modules 1a stacked on the first battery modules 1b.

In some embodiments, each of the battery module 1 includes a first battery module 1b, and a second battery module 1a stacked on the first battery module 1b.

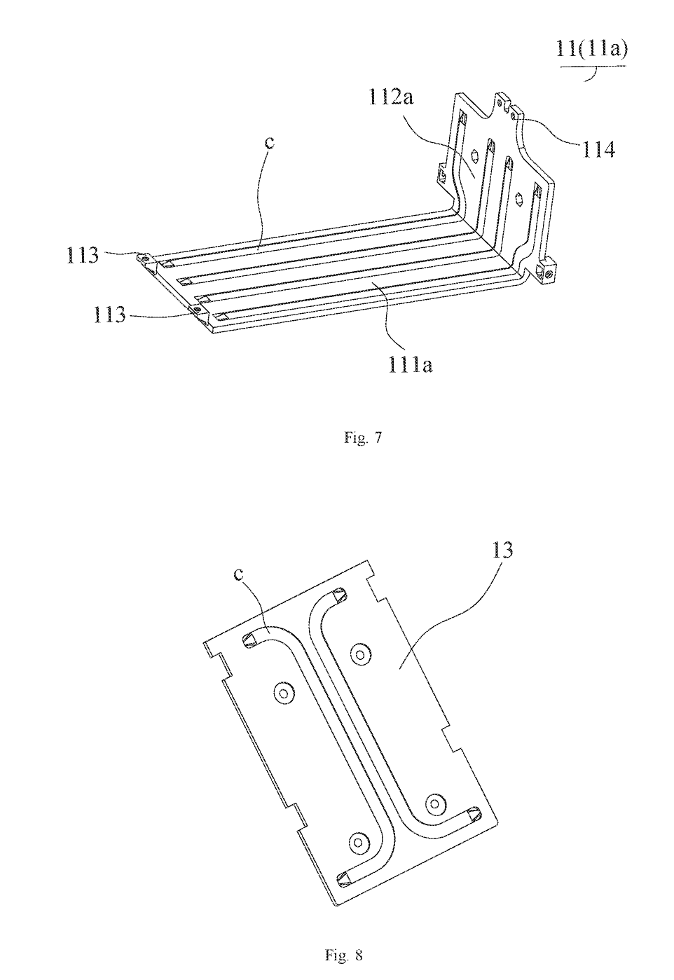

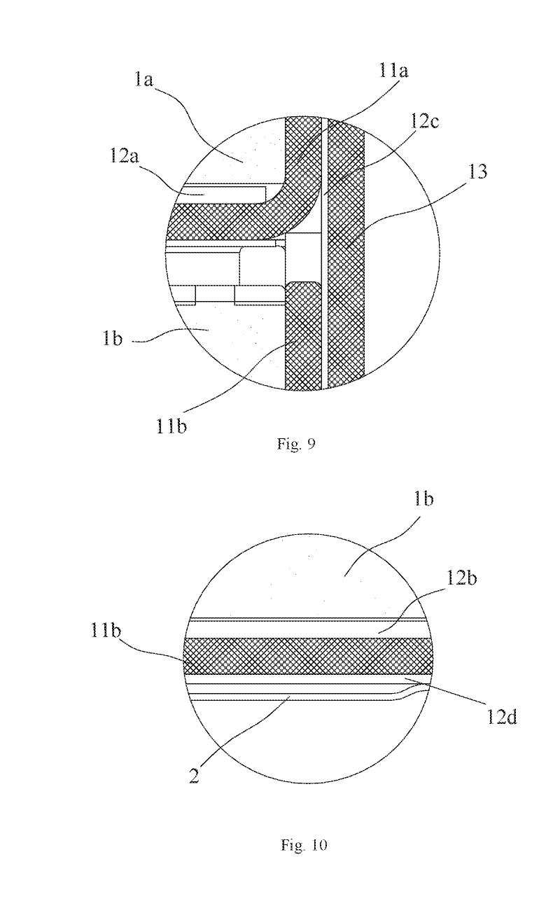

As shown in FIG. 7 and FIG. 9, a module cooling plate 11 is disposed outside of the second battery module 1a, specifically a second module cooling plate 11a. The second module cooling plate 11a includes a first bottom plate 111a disposed at a bottom of the second battery module 1a and a first side plate 112a connected to a side surface of the second battery module 1a.

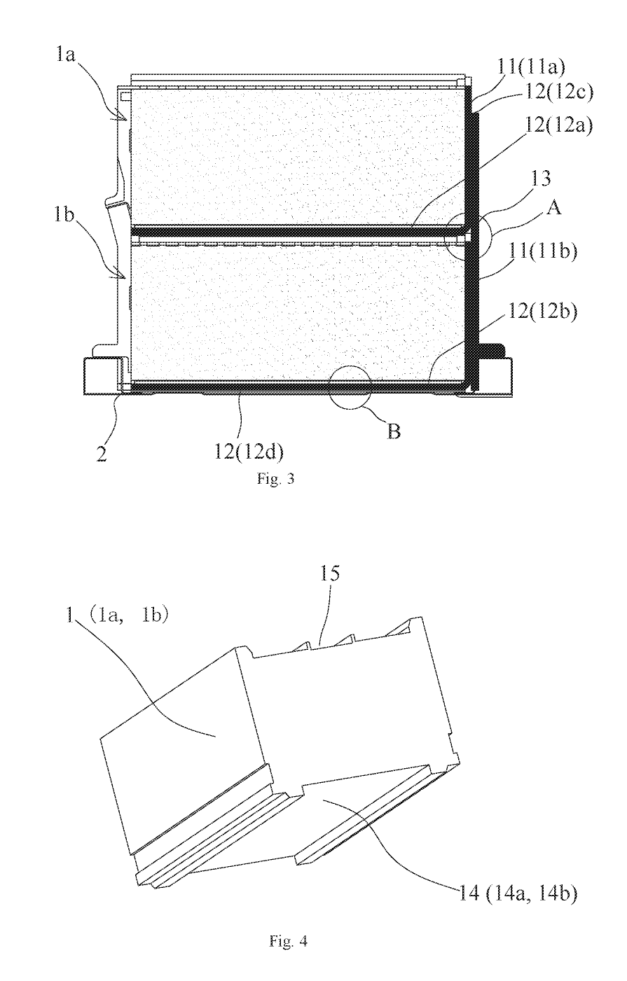

As shown in FIG. 3 and FIG. 8, a first side heat-conducting plate is disposed at an outer side of the first side plate 112a of the second module cooling plate 11a and heat-conductively connected with the first side plate 112a.

Both the first bottom plate 111a and the first side plate 112a have a heat pipe c disposed therein respectively, and the heat pipe c of the first bottom plate 111a and the heat pipe c of the first side plate 112a are in communication with each other, so as to transfer heat of the first bottom plate 111a to the first side plate 112a. The first side heat-conducting plate has a heat pipe c disposed therein and heat-conductively connected to the tray 2.

Since the first battery module 1b is disposed in the lower layer and directly installed on the tray 2, heat of the first battery module 1b can be transferred to the tray 2 directly, and therefore, it may not be necessary to provide a module cooling plate 11 outside of the first battery module 1b, similar to the second battery module 1a. However, as a preferable embodiment, a module cooling plate 11 may be provided outside of the first battery module 1b and heat-conductively connected to the tray 2, for example, a first module cooling plate 11b, so as to improve a thermal conductivity thereof. It should be noted that the first module cooling plate 11b disposed outside of the first battery module 1b and the second module cooling plate 11a disposed outside of the second battery module 1a may be the same or different. In some embodiments, the first module cooling plate 11b disposed outside of the first battery module 1b and the second module cooling plate 11a disposed outside of the second battery module 1a are the same. That is, as shown in FIGS. 3, 6 and 8-10, the first module cooling plate 11b disposed outside of the first battery module 1b includes a second bottom plate 111b and a second side plate 112b, the second bottom plate 111b is disposed to a bottom of the first battery module 1b, and the second side plate 112b is connected to a side surface of the first battery module 1b. Both the second bottom plate 111b and the second side plate 112b have a heat pipe c disposed therein respectively, and the heat pipe c of the second bottom plate 111b and the heat pipe c of the second side plate 112b are in communication with each other, so as to transfer heat of the second bottom plate 111b to the second side plate 112b. A second side heat-conducting plate is disposed at an outer side of the second side plate 112b. In some embodiments, the second side heat-conducting plate is heat-conductively connected with the second side plate 112b, and the second side heat-conducting plate has a heat pipe c disposed therein and heat-conductively connected to the tray 2.

The first side heat-conducting plate disposed at the outer side of the first side plate 112a and the second side heat-conducting plate disposed at the outer side of the second side plate 112b may be designed as two separate plate elements, and also, the first side heat-conducting plate disposed at the outer side of the first side plate 112a and the second side heat-conducting plate disposed at the outer side of the second side plate 112b may be designed as one integrally molded plate element. In some embodiments, as shown in FIG. 3, one side heat-conducting plate 13 is adopted and heat-conductively connected with the second side plate 112b disposed outside of the first battery module 1b and the first side plate 112a disposed outside of the second battery module 1a.

The heat pipe c may be made of various kinds of metal pipes having excellent heat conductivity. For example, the heat pipe c may be manufactured by flattening a copper pipe. By utilizing the phase change principle and the capillary action, the heat pipe c can realize a long-distance and high-efficient heat transfer under an extremely small temperature difference without external energy. The heat pipe c may be bent and configured to have a corresponding shape according to shapes of the first and second battery modules 11a, 11b and the side heat-conducting plate 13, and the heat pipe c may be embedded into the first and second module cooling plates 11a, 11b and the side heat-conducting plate 13. The heat pipe c has a heat conducting liquid filled therein, and the heat conducting liquid may be any liquid having an excellent heat conducting performance, such as water, Freon and so on. It should be noted that a cross section of the heat pipe c may have a circular shape, an oval shape and a square shape. The heat pipe c may be fixed to the first and second module cooling plates 11a, 11b and the side heat-conducting plate 13 via welding or bonding. In some embodiments, a pipe groove is formed in each of the first and second module cooling plates 11a, 11b and the side heat-conducting plate 13, and the heat pipe c is embedded in the pipe groove while being welded or bonded thereto. Certainly, the heat pipe c may be integrally molded in the first and second module cooling plates 11a, 11b and the side heat-conducting plate 13. There is no particular limitation to a size of the heat pipe c, and the size of the heat pipe c can be designed according to actual needs. Taking a copper pipe as an example, a flattened copper pipe may generally have a thickness of 3 millimeters and a width of 13 millimeters, or have a thickness of 1.5 millimeters and a width of 8 millimeters.

The phrase “heat-conductively connected” means that two structures or elements which need to conduct heat therebetween are connected with each other via surface contacting, fitting or other common methods, so as to realize direct or indirect heat transfer between the two structures or elements.

In some embodiments, the side heat-conducting plate 13 may be directly connected to the tray 2 so as to transfer heat to the tray 2 directly. Thus, heat generated from the battery modules 1 (such as the first battery module 1b and the second battery module 1a) can be transferred to the side heat-conducting plate 13 through the module cooling plates 11 (such as the first and second module cooling plates 11b, 11a), and then the heat can be further transferred to the tray 2 via the side heat-conducting plate 13. Or, heat generated from the lowest layer of battery module 1 (namely the first battery module 1b) can be directly transferred to the tray 2 through the second bottom plate 111b, so as to cool down the battery module 1.

The module cooling plates 11 (namely the first and second module cooling plates 11b, 11a) are configured to absorb the heat generated from the battery modules 1 (for example, the second battery module 1a and the first battery module 1b) through the bottom plates (for example, the first bottom plate 111a and the second bottom plate 111b), and then transfer the heat out through the bottom plates and the side plates (for example, the first side plate 112a and the second side plate 112b). When the battery module 1 is disposed in the lower layer, namely the battery module 1 is configured as the first battery module 1b, heat of the first battery module 1b may be directly transferred to the tray 2 through the second bottom plate 111b. When the battery module 1 is disposed in the upper layer, namely the battery module 1 is configured as the second battery module 1a, heat of the second battery module 1a is firstly transferred to the side heat-conducting plate 13 via the second module cooling plate, and then the heat is further transferred to the tray 2. As shown in FIG. 6 and FIG. 7, in one embodiment, the module cooling plate 11 is configured to have an L shape, a long part of the L-shaped module cooling plate 11 is the bottom plate, and a short part of the L-shaped module cooling plate 11 is the side plate. Two side plates may be provided and adhered to two opposite side surfaces of the battery module 1 respectively, and thus the module cooling plate 11 has an U shape. In order to fix and install the module cooling plate 11, the bottom plate thereof is provided with a first connecting portion 113, and the side plate thereof is provided with a second connecting portion 114.

It should be noted that there is no particular limitation to an installation manner of the module cooling plate 11, as long as the module cooling plate 11 can be stably fixed, and meanwhile heat can be transferred well. For example, in some embodiments, as shown in FIG. 4, a bottom groove 14 is formed in the bottom of the battery module 1, and the bottom plate of the module cooling plate 11 is installed in the bottom groove 14. Specifically, a first bottom groove 14b is formed in the bottom of the first battery module 1b, and the second bottom plate 111b of the first module cooling plate 11b is installed in the first bottom groove 14b; a second bottom groove 14a is formed in the bottom of the second battery module 1a, and the first bottom plate 111a of the second module cooling plate 11a is installed in the second bottom groove 14a.

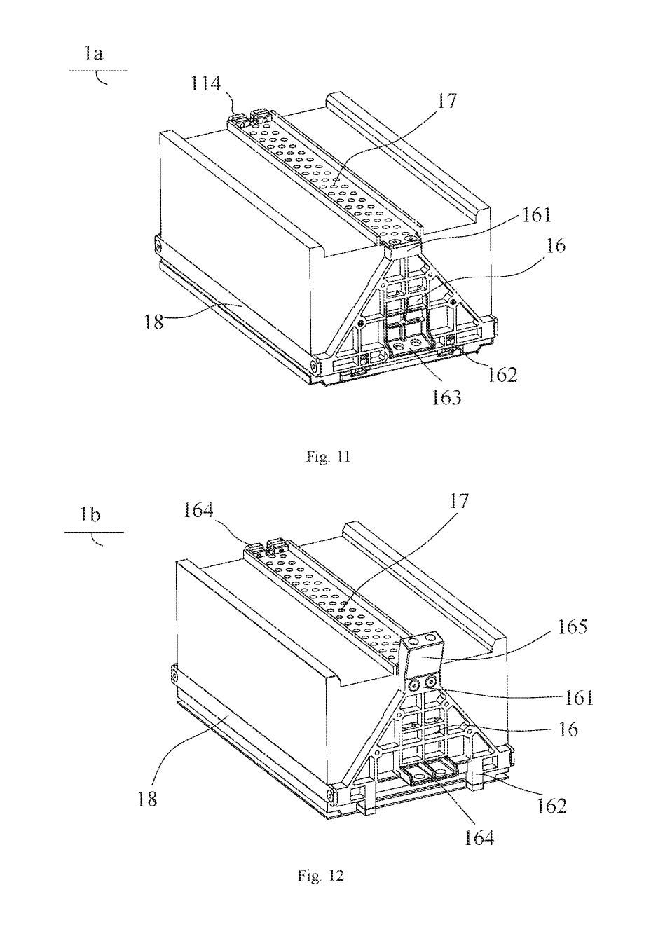

It should be noted that there is no particular limitation to the fixing method of the battery module 1, and the battery module 1 may be fixed via a method known by those skilled in the art, such as a screw connection, a snap-fit connection, and so on. In one embodiment, in order to fix the battery module stably and improve a heat transfer efficiency thereof, as shown in FIG. 11 and FIG. 12, a fixing plate 16 is disposed at another side of each of the first battery module 1b and the second battery module 1a opposite to a side thereof at which the side plate is disposed, and the fixing plates 16 disposed to the first battery module 1b and the second battery module 1a are substantially the same with each other, having a triangle shape. A lower connecting portion 162 is provided at a lower end of the fixing plate 16, and an upper connecting portion 161 is provided at an upper end of the fixing plate 16. A top groove 15 is formed in a top of the battery module 1 (for example, the first battery module 1b and the second battery module 1a), and a connecting rib 17 is disposed in the top groove 15. Also, a pull rod 18 is provided at each of other three sides of the battery module 1, except the side at which the fixing plate 16 is disposed. The fixing plate 16 is threadedly connected to the above pull rods 18 at the three sides to realize fastening of the battery module 1 in a horizontal direction. And also, the first connecting portion 113 of the module cooling plate 11 is threadedly connected to the lower connecting portion 162 of the fixing plate 16, the second connecting portion 114 of the module cooling plate 11 is threadedly connected to one end of the connecting rib 17, and the other end of the connecting rib 17 is threadedly connected to the upper connecting portion 161 of the fixing plate 16. Thus, the battery module 1 can be fastened in a longitudinal direction.

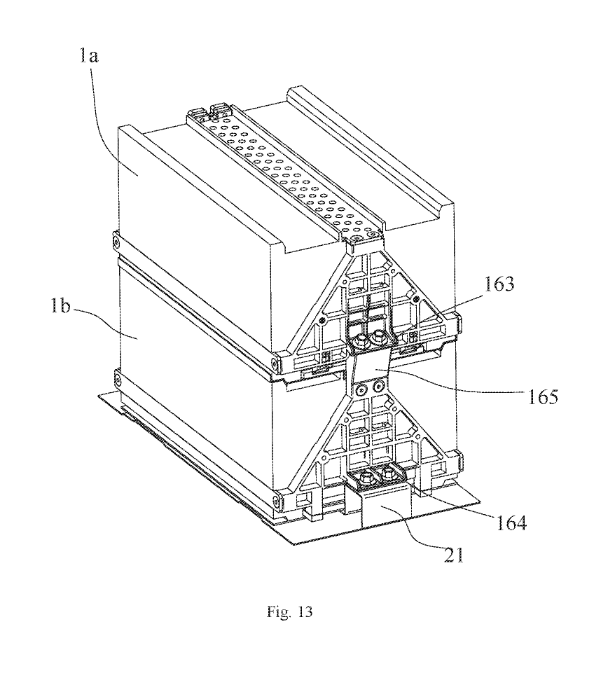

In order to realize a fixed connection between the first battery module 1b and the second battery module 1a, as shown in FIGS. 11-13, a convex connecting portion 165 is provided at the upper end of the fixing plate 16 of the first battery module 1b, a connecting step 163 configured to be fitted with the convex connecting portion 165 is provided at the lower end of the fixing plate 16 of the second battery module 1a, and the convex connecting portion 165 is threadedly connected with the connecting step 161. Meanwhile, a tray connecting portion 164 is provided at a lower end of the first battery module 1b, a fixing and installing bracket 21 is provided on the tray 2 correspondingly, and the tray connecting portion 164 is threadedly connected with the fixing and installing bracket 21. In this case, the first battery module 1b and the second battery module 1a can be fixedly connected together, and the stacked battery modules can be fixed and installed on the tray 2. It should be noted that “threadedly connected” is known by those skilled in the art. For example, a threaded hole is formed in each of two elements to be threadedly connected, a bolt passes through the threaded holes and is locked by a nut, and then “threadedly connected” is realized.

In some embodiments, a heat-conducting pad 12 is respectively provided between the first battery module 1b and the first module cooling plate 11b disposed outside of the first battery module 1b, between the second battery module 1a and the second module cooling plate 11a disposed outside of the second battery module 1a, between the side heat-conducting plate 13 and the first side plate 112a of the second module cooling plate 11a, and between the side heat-conducting plate 13 and the second side plate 112b of the first module cooling plate 11b. With the heat-conducting pad 12, the battery module 1 and the module cooling plate 11 can be effectively brought into contact with each other, and also the side heat-conducting plate 13 and the side plate of the module cooling plate 11 can be effectively brought into contact with each other, so as to improve a heat transfer efficiency. Furthermore, the heat-conducting pad 12 has a buffering function. The heat-conducting pad 12 may be made of thermally conductive silicone rubber or silicone rubber.

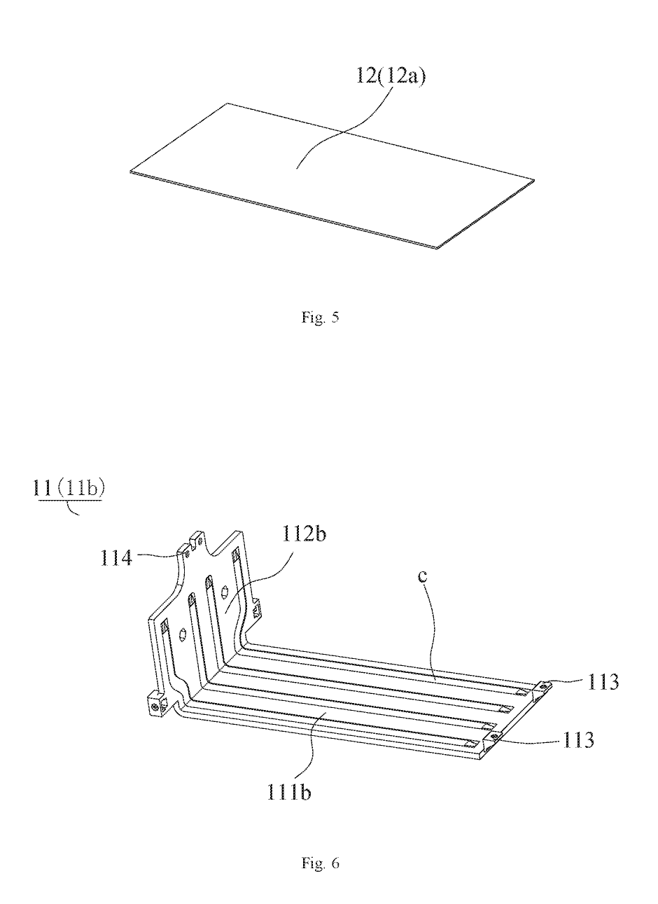

In some embodiments, the second bottom plate 111b of the first module cooling plate 11b is directly in contact with the tray 2 via the heat-conducting pad 12. For the purpose of distinguishing, the heat-conducting pad 12 disposed between the second bottom groove 14a formed in the bottom of the second battery module 1a and the second module cooling plate 11a is called as a second module heat-conducting pad 12a, the heat-conducting pad 12 disposed between the first bottom groove 14b formed in the bottom of the first battery module 1b and the first module cooling plate 11b is called as a first module heat-conducting pad 12b, the heat-conducting pad 12 disposed between the side plate of the module cooling plate 11 (for example, the first module cooling plate 11b and the second module cooling plate 11a) and the side heat-conducting plate 13 is called as a side heat-conducting pad 12c, and the heat-conducting pad 12 disposed between the second bottom plate 111b of the first module cooling plate 11b and the tray 2 is called as a tray heat-conducting pad 12d. As shown in FIG. 5, a structure of the second module heat-conducting pad 12a is showed, and other heat-conducting pads 12 may have a substantially same structure, for example, having a sheet shape. It should be noted that the shape of the heat-conducting pad 12 may be designed according to the shapes of the module cooling plate 11 and the side heat-conducting plate 13.

Since the power battery pack utilizes the module cooling plate 11 and the side heat-conducting plate 13 mentioned above, as shown in FIG. 2, heat generated from single batteries in the first battery module 1b is directly transferred to the tray 2 via the tray heat-conducting pad 12d after passing through the first module heat-conducting pad 12b and the first module cooling plate 11b, so as to dissipate heat, heat generated from single batteries in the second battery module 1a is transferred to the side heat-conducting plate 13 via the second module heat-conducting pad 12a, the second module cooling plate 11a and the side heat-conducting pad 12c, and then is further transferred to the tray 2 via the side heat-conducting pad 12c, the first module cooling plate 11b and the tray heat-conducting pad 12d, so as to dissipate heat, or heat generated from single batteries in the second battery module 1a is directly transferred to the tray 2 after passing through the second module heat-conducting pad 12a, the second module cooling plate 11a, the side heat-conducting pad 12c and the side heat-conducting plate 13, so as to dissipate heat.

With the power battery pack according to embodiments of the present disclosure, the battery modules 1 can be arranged along the horizontal direction and in multiple stacked layers within a limited space depending on a reserved space of the electrical vehicle, in which the module cooling plate 11 and the side heat-conducting plate 13 occupy only a small space, and the pipes c disposed in the module cooling plate 11 and the side heat-conducting plate 13 transfer heat fast, so heat generated from the battery modules 1 can be transferred to the tray 2 evenly, quickly and efficiently, so as to dissipate heat. Moreover, the power battery pack has a simple structure and a relative low cost.

Embodiments of the present disclosure also provide an electrical vehicle, which includes a power battery pack mentioned above. The power battery pack is well described above, and thus a detailed description thereof is omitted herein.

The electrical vehicle according to embodiments of the present disclosure includes the above power battery pack, such that the battery modules 1 can be arranged along the horizontal direction and in multiple stacked layers within a limited space depending on a reserved space of the electrical vehicle, in which the module cooling plate 11 and the side heat-conducting plate 13 occupy only a small space, and the pipes c disposed in the module cooling plate 11 and the side heat-conducting plate 13 transfer heat fast, so heat generated from the battery modules 1 can be transferred to the tray 2 evenly, quickly and efficiently, so as to dissipate heat.

Although the embodiments of the present disclosure have been shown and described, those of ordinary skill in the art can understand that multiple changes, modifications, replacements, and variations may be made to these embodiments without departing from the principle and purpose of the present disclosure.

What is claimed is:

1. A power battery pack, comprising:
a tray;
a plurality of battery modules disposed in the tray, the plurality of battery modules each comprising a first battery module disposed on the tray and a second battery module stacked on the first battery module;
a second module cooling plate disposed outside of the second battery module, the second module cooling plate comprising a first bottom plate disposed to a bottom of the second battery module and a first side plate connected to a side surface of the second battery module; and
a first side heat-conducting plate disposed at an outer side of the first side plate of the second module cooling plate and heat-conductively connected with the first side plate,
wherein both the first bottom plate and the first side plate have a heat pipe disposed therein respectively, the heat pipe of the first bottom plate and the heat pipe of the first side plate are in communication with each other to transfer heat of the first bottom plate to the first side plate, and the first side heat-conducting plate has a heat pipe disposed therein and heat-conductively connected to the tray.

2. The power battery pack of claim 1, further comprising a first module cooling plate disposed outside of the first battery module and heat-conductively connected to the tray.

3. The power battery pack of claim 2, wherein the first module cooling plate comprises a second bottom plate disposed to a bottom of the first battery module and a second side plate connected to a side surface of the first battery module;
wherein both the second bottom plate and the second side plate have a heat pipe disposed therein respectively, the heat pipe of the second bottom plate and the heat pipe of the second side plate are in communication with each other to transfer heat of the second bottom plate to the second side plate; and
wherein the power battery pack further comprises a second side heat-conducting plate disposed at an outer side of the second side plate of the first module cooling plate and heat-conductively connected with the second side plate, and the second side heat-conducting plate has a heat pipe disposed therein and heat-conductively connected to the tray.

4. The power battery pack of claim 2, wherein both the first module cooling plate and the second module cooling plate are configured to have a U shape or an L shape.

5. The power battery pack of claim 4, wherein a first bottom groove is formed in the bottom of the first battery module, and the second bottom plate of the first module cooling plate is installed in the first bottom groove; and
wherein a second bottom groove is formed in the bottom of the second battery module, and the first bottom plate of the second module cooling plate is installed in the second bottom groove.

6. The power battery pack of claim 3, wherein a heat-conducting pad is disposed between the first battery module and the first module cooling plate, a heat-conducting pad is disposed between the second battery module and the second module cooling plate, a heat-conducting pad is disposed between the first side heat-conducting plate and the first side plate of the second module cooling plate, and a heat-conducting pad is disposed between the second side heat-conducting plate and the second side plate of the first module cooling plate.

7. The power battery pack of claim 6, wherein the second bottom plate of the first module cooling plate is directly in contact with the tray via a heat-conducting pad, and a lower end of the second side heat-conducting plate is connected to the tray.

8. The power battery pack of claim 1, wherein the heat pipe has a heat conducting liquid filled therein.

9. The power battery pack of claim 3, wherein the heat pipe is fixed to the first and second module cooling plates and the first and second side heat-conducting plates via welding or bonding.

10. The power battery pack of claim 3, wherein the heat pipe is formed in the first and second module cooling plates and the first and second side heat-conducting plates via integral molding.

11. An electrical vehicle, comprising a power battery pack of claim 1.
